(19) United States
(12) Patent Application Publication
(10) Pub. No.: US 2017/0170523 A1
(43) Pub. Date: Jun. 15, 2017

(54) SOLID-STATE BATTERY AND MANUFACTURING METHOD THEREOF

(71) Applicant: Hyundai Motor Company, Seoul (KR)

(72) Inventors: Ji Na Kim, Anyang (KR); Ho Taek Lee, Seoul (KR); Eun Ji Kwon, Gunpo (KR); Sang Jin Park, Bucheon (KR)

(21) Appl. No.: 15/289,607

(22) Filed: Oct. 10, 2016

(30) Foreign Application Priority Data
Dec. 10, 2015 (KR) 10-2015-0176299

(51) Int. Cl. H01M 10/0585; H01M 10/0525

(52) U.S. Cl. CPC H01M 10/0585; H01M 10/0525; H01M 2220/20; H01M 2300/0065

(57) ABSTRACT

Disclosed are a solid-state battery and a manufacturing method thereof. The solid-state battery includes two or more unit cells which are laminated by a serial or parallel method. In particular, the two or more unit cells are laminated such that a current collector of a unit cell contacts an electrode layer of a next unit cell. Accordingly it does not need to pressurize with a high pressure, which does not result in any short circuit between the unit cells, and the solid-state battery can stably operate.

### CROSS-REFERENCE TO RELATED APPLICATION

This application claims under 35 U.S.C. §119(a) the benefit of priority to Korean Patent Application No. 10-2015-0176299 filed on Dec. 10, 2015, the entire contents of which are incorporated herein by reference.

### BACKGROUND

(a) Technical Field

The present invention relates to a solid-state battery wherein two or more unit cells are laminated by a serial or parallel method, and a manufacturing method thereof.

(b) Background Art

A secondary cell has been widely used from a large size device, for example, a vehicle, an energy storage system, and the like to a small size device, for example, a cellular phone, a camcorder, a laptop computer, and the like.

Among various secondary cells, a lithium secondary cell advantageously has a high energy density and a large capacity per unit area as compared to a nickel-manganese cell and a nickel-cadmium cell.

However, the above lithium secondary cell may not be good for a next generation battery for a vehicle, since it may be easily overheated, and its energy density is about 360 Wh/kg, and the output thereof is bad.

For this reason, an interest in a solid-state battery which has a high output and a high energy density has been increased. The solid-state battery theoretically has about 2600 Wh/kg of an energy density, which is about 7 times greater than a conventional lithium secondary cell, so the solid-state battery can be employed as a power source of an electric vehicle.

Moreover, when a solid-state battery is made in such a way to laminate unit cells into a predetermined structure, a higher operation voltage or capacity may be obtained.

A method for manufacturing a solid-state battery by laminating unit cells may be categorized into a parallel method and a serial method. The parallel method is a method wherein the unit cells are laminated by positioning the electrode layers having the same polarities on both surfaces of a current collector, and the serial method is a method wherein the electrode layers having different polarities are positioned on both surfaces of the current collector.

The Korean patent laid-open publication No. 10-2014-0009497 has disclosed a solid-state battery wherein unit cells are laminated by the serial method using a bipolar electrode. According to the above Korean patent publication, since the unit cells are configured in a bipolar electrode structure, a solid electrode layer and an electrode layer (an anode layer or a cathode layer) are arranged contacting each other when laminating the unit cells. Since lithium ions should be conducted between the solid electrolyte layer and the electrode layer, both the layers should be strongly bonded. To this end, a process wherein two or more unit cells are laminated and are pressed with a high pressure should be carried out.

However, in the above case, a short circuit may occur between the unit cells due to a non-uniform pressure which is applied to each unit cell. When the pressure is reduced in an effort to prevent such a short circuit, the bonding force between the solid electrolyte layer and the electrode layer may be deteriorated, which may result in reduced capacity.

### SUMMARY OF THE INVENTION

In preferred aspects, the present invention provides a solid-state battery and a manufacturing method thereof which may including laminating two or more unit cells, such that the battery can operate stably without any short circuit between the unit cells.

In one aspect, provided is a solid-state battery which may include two or more of the unit cells, and each unit cell may include: a current collector, a solid electrolyte layer, and an electrode layer formed of an anode layer and a cathode layer. In one preferred aspect, the two or more of the unit cells may be laminated, for example, the neighboring unit cells may be laminated such that a current collector of one unit cell (e.g., a first unit cell) may contact an electrode layer of a next unit cell (e.g., a second unit cell).

In the solid-state battery according to the present invention, the unit cell may have a structure comprising a current collector, an anode layer, a solid electrolyte layer and a cathode layer which may be sequentially laminated in this order, and the neighboring unit cells may be laminated in such a way that a current collector of one unit cell (e.g., first unit cell) may contact a cathode layer of a next unit cell (e.g., second unit cell), thereby manufacturing a solid-state battery of a serial cell structure.

In the solid-state battery according to the present invention, the unit cell may include a first unit cell comprising a first current collector, a first anode layer, a first solid electrolyte layer and a first cathode layer, which may be sequentially laminated in this order, and a second unit cell comprising a second current collector, a second cathode layer, a second solid electrolyte layer and a second anode layer, which may be sequentially laminated in this order. In particular, the first unit cell and the second unit cell may be laminated such that the first unit cell and the second unit cell may be alternately laminated, and the electrode layers (e.g. the first and the second cathode layer, or the first and the second anode layer) having same polarities may be disposed on both surfaces of the first current collector or the second current collector, thereby manufacturing a solid-state battery in a parallel structure.

In the solid-state battery according to the present invention, the solid-state battery may further comprise an electron conductivity-reinforced layer interposed between the neighboring unit cells.

In another aspect, the present invention provides a manufacturing method of a solid-state battery. The method may include (1) preparing a unit cell by forming, on a current collector, a solid electrolyte layer, and an electrode layer formed of a cathode layer and an anode layer; (2) pressurizing the unit cell; and (3) bonding two or more unit cells in such a way that a current collector of one unit cell may contact an electrode layer of a next unit cell.

Preferably, the unit cell may be prepared by sequentially forming an anode layer, a solid electrolyte layer and a cathode layer on the current collector in this order. Preferably, when bonding the two or more of the unit cells, a serial cell structure may be formed such that the current collector of the one unit cell may contact a cathode layer of the next unit cell.

Preferably, the unit cell may be prepared by steps comprising: preparing a first unit cell by sequentially forming a first anode layer, a first solid electrolyte layer and a first cathode layer on a first current collector in this order; and a preparing a second unit cell by sequentially forming a second cathode layer, a second solid electrolyte layer and a second anode layer on a second current collector in this order. In addition, the two or more unit cells may be bonded to form a parallel cell structure such that the first unit cell and the second unit cell may be alternately bonded, and the electrode layers having the same polarities (cathodes) may be disposed on both surfaces of the second current collector.

In the manufacturing method of a solid-state battery according to the present invention, an electron conductivity-reinforced layer may be interposed between the neighboring unit cells when bonding the unit cells.

Further provided is a vehicle that may comprise the solid-state battery as described herein.

Other aspects and preferred embodiments of the invention are discussed infra.

The present invention is able to provide the following advantageous effects.

The solid-state battery according to the present invention may provide a stable operation without any short circuit between unit cells since it does not need to pressurize with a high pressure to laminate neighboring unit cells where a current collector of one unit cell and an electrode layer of another unit cell are may be contacting each other.

Moreover, the solid-state battery according to the present invention may easily determine a short circuit state of each unit cell by measuring an open circuit voltage of each unit cell. Recovery may also be easy since a short circuit cell can be selectively removed.

The advantageous effects of the present invention are not intended to limit the above-mentioned effects. It should be understood that the advantageous effects of the present invention cover all possible effects in the following descriptions.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 illustrates a configuration of a unit cell in a conventional solid-state battery wherein unit cells are laminated;

FIG. 2 illustrates a conventional solid-state battery wherein unit cells are laminated;

FIG. 3 illustrates an exemplary unit cell according to an exemplary embodiment of the present invention;

FIG. 4 is illustrates an exemplary solid-state battery according to an exemplary embodiment of the present invention;

FIG. 5 illustrates an exemplary manufacturing method of the exemplary solid-state battery in FIG. 4 according to an exemplary embodiment of the present invention;

FIG. 6 illustrates an exemplary process (S1) of preparing an exemplary unit cell in FIG. 5 according to an exemplary embodiment of the present invention;

FIG. 7 illustrates an exemplary unit cell according to an exemplary embodiment of the present invention;

FIG. 8 illustrates an exemplary solid-state battery according to another exemplary embodiment of the present invention;

FIG. 9 illustrates an exemplary manufacturing method of the exemplary solid-state battery in FIG. 8 according to an exemplary embodiment of the present invention;

FIG. 10 shows a result of an experimental example 1 according to the present invention;

FIG. 11 shows a result of an embodiment 1 of an experimental example 2 according to the present invention; and

FIG. 12 shows a result of an embodiment 2 of an experimental example 2 according to the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

The terminology used herein is for the purpose of describing particular exemplary embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

If any components are judged to make unclear the subject matters of the present invention, the configuration and function of such components will be omitted.

In the present invention, the term “a cathode layer” represents a layer which may contain a cathode active material, for example, a conduction material, a binder, a solid electrolyte, and the like. In the present invention, the term “an anode layer” represents a layer which may contain an anode active material, for example, a conduction material, a binder, a solid electrolyte, and the like.

In the present invention, the term “a solid electrolyte layer” and “a current collector” have the same definition as the functions, operations, etc. of which are known in a technical field to which the present invention pertain, so the detailed description thereon will be omitted.

The present invention provides a solid-state battery comprising two or more unit cells and a manufacturing method thereof. Each unit cell may comprise a current collector, a solid electrolyte layer, and an electrode layer (i.e. an anode layer and a cathode layer), which may be laminated.

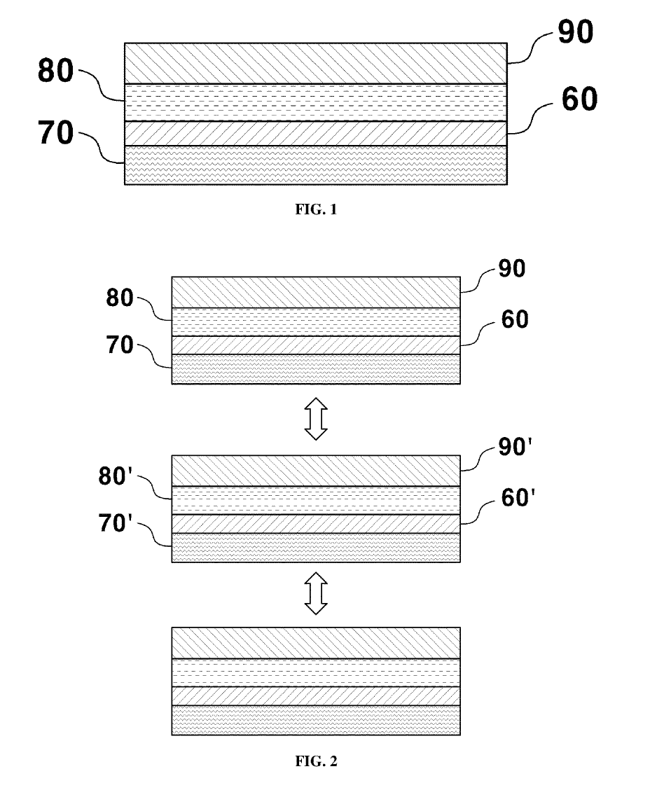

FIG. 1 illustrates a unit cell in a conventional solid-state battery wherein unit cells are laminated. For example, FIG. 1 shows the unit cells of a solid-state battery which are laminated by a serial method.

In the related arts, the bipolar electrode has been manufactured by coating an electrode layer having different polarities on both surfaces of a current collector. As shown in FIG. 1, a cathode layer 70 is formed on one surface of a current collector 60, and an anode layer 80 is formed on the other side thereof. A unit cell may be manufactured by forming a solid electrolyte layer 90.

As illustrated in FIG. 2, a solid-state battery may be manufactured by laminating the unit cells such that a solid electrolyte layer 90′ of a first unit cell and an electrode layer (more specifically, a cathode layer 70) of a second unit cell may contact each other.

In such a solid-state battery, since lithium ions move through an interface between a solid electrolyte layer and an electrode layer, so the interface between both the layers should be densely formed. When the two or more unit cells each of which has a conventional configuration are laminated, a desired interface between the solid electrolyte layer and the electrode layer may not be suitably formed only by bonding the neighboring unit cells. For this reason, the conventional solid-state battery should be pressurized with a high pressure or should be heat-treated at a high temperature finally after the unit cells have been laminated.

However, when a high pressure is applied to laminate two or more unit cells, a uniform pressure may not be applied to each unit cell. Accordingly, a short circuit may frequently occur between the unit cells.

When the pressure is reduced to prevent the above mentioned problem, for example, the short cut, the interface between the solid electrolyte layer and the electrode layer may not be formed densely, which will result in a reduced battery capacity.

In the conventional solid-state battery, it needs to supply a high pressure between the solid electrolyte layer and its neighboring electrode layer. In this case, a strong bonding force may be made between the above two layers, so the unit cells cannot be easily separated from each other. For this reason, it is hard to measure the open circuit voltage of the unit cell. When any short circuit occurs in the unit cells, corresponding short circuit unit cell may be difficult to find out. Even though the short circuit unit cell is found out, it is not easy to selectively remove the short circuit unit cell. Therefore the recovery of the solid-state battery may not be easy.

Accordingly, the present invention is made in an effort to solve the above problems. In the present invention, the unit cells may have a new structure which is different from the conventional structure.

More specifically, the present invention may provide a solid-state battery comprising two or more unit cells and each of the unit cell may comprise a current collector, a solid electrolyte layer, and an electrode layer (an anode layer and a cathode layer), which may be laminated. The current collector of one unit cell among the neighboring unit cells contacts the electrode layer of a next unit cell.

The solid-state battery wherein two or more unit cells may be laminated by a serial method according to an exemplary embodiment of the present invention will be described.

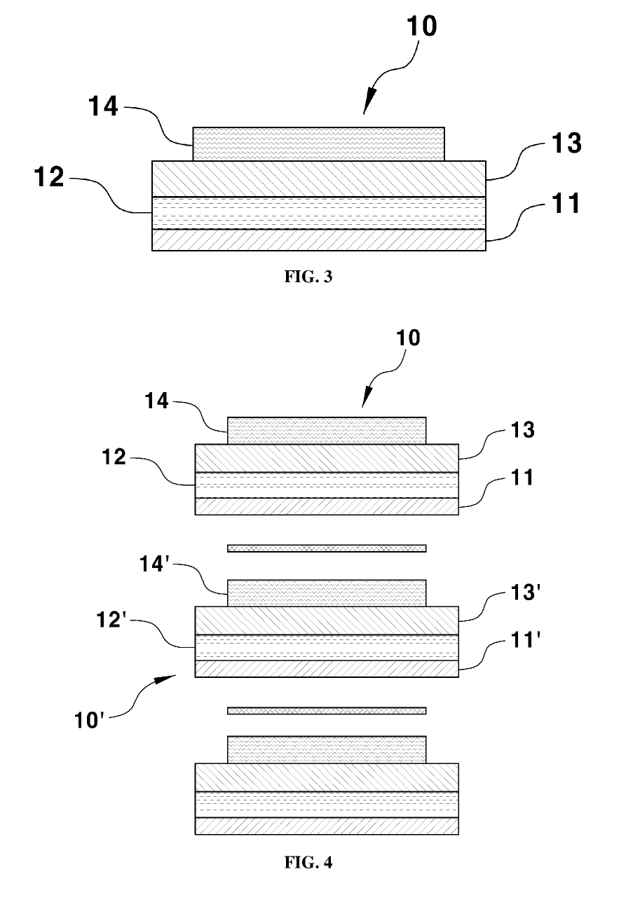

As illustrated in FIG. 3, a unit cell 10 according to an exemplary embodiment of the present invention may be configured in such a way that a current collector 11, an anode layer 12, a solid electrolyte layer 13, and a cathode layer 14 may be sequentially laminated in this order.

As illustrated in FIG. 4, a solid-state battery having a serially connected structure may be manufactured by laminating two or more unit cells such that the current collector 11 of the first unit cell 10 may contact with the second cathode layer 14′ of the second unit cell 10′. The serial method according to the present invention represents a method wherein the unit cells may be laminated such that the electrode layers having polarities different from each other may be disposed on both surfaces of the current collector 11 from the first unit cell.

An electron conductivity-reinforced layer 15 may be interposed between the neighboring unit cells. The above electron conductivity-reinforced layer 15 may be provided to reduce any resistance between the electrode layer (an anode layer and a cathode layer) and the current collector. Any possible poor contact between the electrode layer and the current collector due to a volume expansion of the electrode layer during the charging and discharging of the battery may be prevented. The specific description thereon will be provided later.

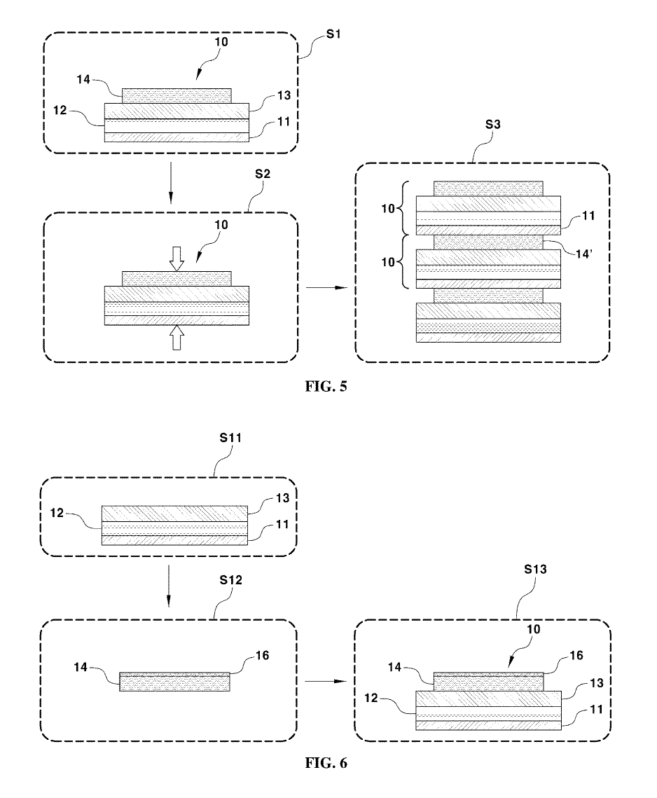

As shown in FIG. 5, a manufacturing method of a solid-state battery may provide two or more unit cells which may be laminated by a serial method according to an exemplary embodiment of the present invention. The method may include: (1) a step S1 of preparing a unit cell 10 by sequentially forming an anode layer 12, a solid electrolyte layer 13 and a cathode layer 14 on a current collector 11 in this order; (2) a step S2 of pressurizing the unit cell 10 to integrate the unit cells; and (3) a step S3 of bonding two or more of the unit cells such that the current collector 11 of one unit cell 10 (e.g. first unit cell) and the cathode layer 14′ of a next unit cell 10′ (e.g. second unit cell) contact each other.

As illustrated in FIG. 6, when the unit cell is prepared (S1), the anode layer 12 and the solid electrolyte layer 13 may be sequentially formed on the current collector 11 in this order (S11); forming the cathode layer 14 on a substrate 16, for example, a film, and the like (S12); and contacting the solid electrolyte layer 13 to the cathode layer 14 (S13), thus preparing the unit cell 10.

The anode layer, the solid electrolyte layer and the cathode layer may be formed by any of the known methods. Preferably, the solid electrolyte layer and the cathode layer may be formed by a wet slurry casting method.

In the step S2 when the unit cells are pressurized with a predetermined pressure, the interface between the electrode layer and the solid electrolyte layer may be formed densely. Since the pressure range for pressurizing is well known, so the description thereon will be omitted.

When the unit cells are prepared by the method in FIG. 6, the substrate 16, for example, a film, and the like may be removed after pressurizing the unit cells (S2) and before bonding the unit cells (S3).

In the step S3, the adhesion of each unit cell may be carried out by any of the known methods, but the unit cells may be bonded by coating an adhesive.

Moreover, when laminating each unit cell in the step S3, an electron conductivity-reinforced layer 15 may be interposed between the neighboring unit cells (e.g., between the first unit cell and the second unit cell).

The solid-state battery wherein two or more unit cells may be laminated by a parallel method according to an exemplary embodiment of the present invention will be described.

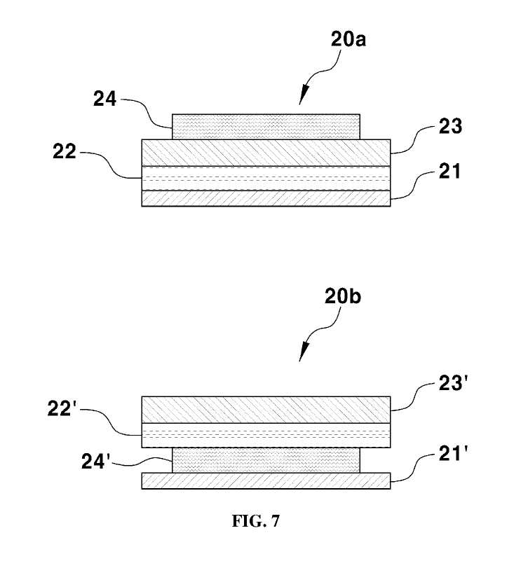

As illustrated in FIG. 7, a unit cell 20 according to an exemplary embodiment of the present invention may be a structure formed of a first unit cell 20a and a second unit cell 20b.

The first unit cell 20a represents a unit cell wherein a first current collector 21, a first anode layer 22, a first solid electrolyte layer 23 and a first cathode layer 24 may be sequentially laminated in this order.

The second unit cell 20b may be a unit cell wherein a second current collector 21′, a second cathode layer 24′, a second solid electrolyte layer 23′ and a second anode layer 22′ may be sequentially laminated in this order.

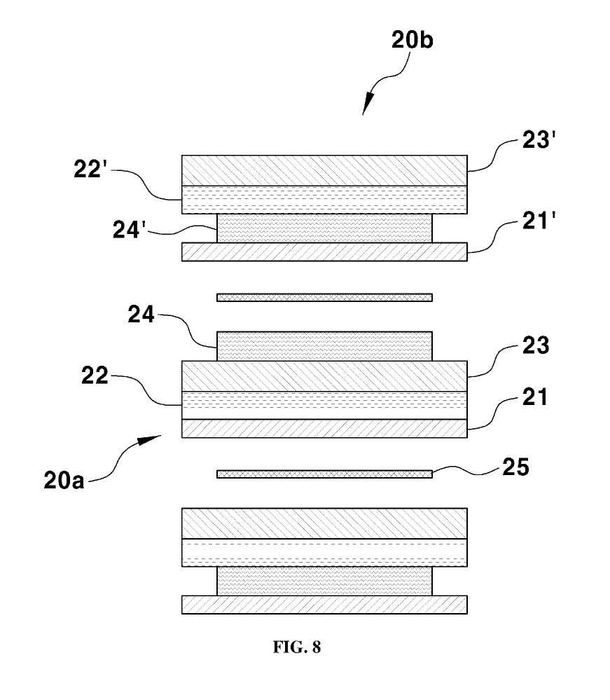

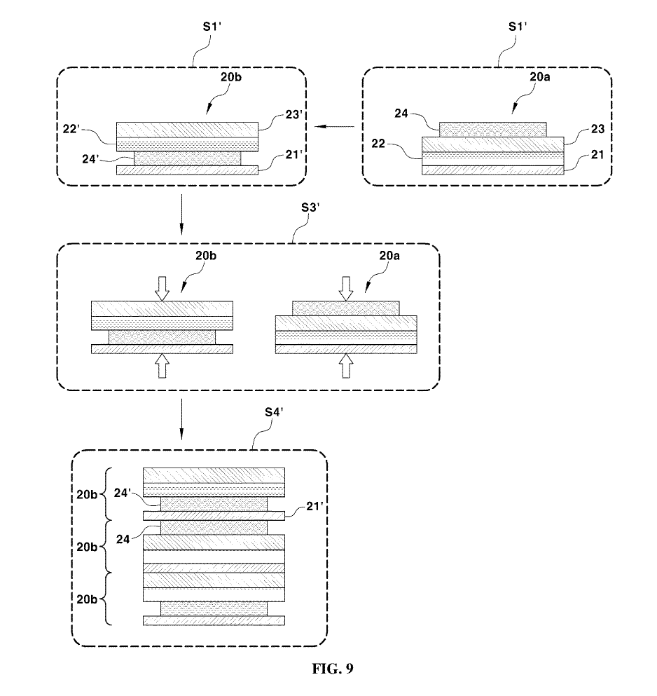

As illustrated in FIG. 8, the solid-state battery having a parallel connection structure can be manufactured by alternately laminating the first unit cell 20a and the second unit cell 20b. The parallel method of the present invention may provide a method wherein the unit cells may be laminated such that the electrode layers having the same polarities may be disposed on both surfaces of the second current collector 21′.

According to an exemplary embodiment of the present invention, an electron conductivity-reinforced layer 25 may be interposed between the neighboring unit cells. The configuration thereof will be described later.

As shown in FIG. 9, a manufacturing method of a solid-state battery may include laminating two or more unit cells by a parallel method. The method according to an exemplary embodiment of the present invention may include: a step S1′ of preparing a first unit cell 20a by sequentially laminating a first anode layer 22, a first solid electrolyte layer 23, and a first cathode layer 24 on a first current collector 21 in this order; a step S2′ of preparing a second unit cell 20b by sequentially laminating a second cathode layer 24′, a second solid electrolyte layer 23′ and a second anode layer 22′ on a second current collector 21′ in this order; a step S3′ of pressurizing the first unit cell 20a and the second unit cell 20b to integrate thereof; and a step S4′ of bonding the first unit cell and the second unit cell such that the first cathode layer 24 and the second cathode layer 24 having the same polarities may be disposed on both surfaces of the second current collector 21′ while alternately laminating the first unit cell 20a and the second unit cell 20b.

The configurations of the anode layer, the solid electrolyte layer and the unit cells may be described herein above, so the descriptions thereon will be omitted.

In another exemplary embodiment of the present invention, an electron conductivity-reinforced layer may be also interposed between the neighboring unit cells (e.g. between the first unit cell and the second unit cell). The descriptions thereof will be omitted so as to avoid repeated descriptions.

The solid-state batteries according to an exemplary embodiment and another exemplary embodiment of the present invention may have the following technical features.

In the conventional solid-state battery, the solid electrolyte layer and the electrode layer may (an anode layer or a cathode layer) contact each other when laminating the unit cells. In the present invention, the current collector and the electrode layer (an anode layer or a cathode layer) may contact each other.

Since the interface between the current collector and the electrode layer does not need to be formed as dense as the interface between the solid electrolyte layer and the electrode layer, the solid-state battery according to the present invention may normally operate even though the unit cells are simply bonded without pressurizing with a high pressure.

In the present invention, the interface between the solid electrolyte layer and the electrode layer (an anode layer and a cathode layer) may be formed dense in such a way to individually pressurize each unit cell. Since each unit cell is individually pressurized, the unit cells may be uniformly pressurized with a higher pressure. For this reason, the interface of each layer may be formed dense, and thus, the short circuit problem may not occur with the unit cells of the conventional solid-state battery.

In the solid-state battery according to various exemplary embodiments of the present invention, although a high pressure may be required when manufacturing each unit cell, the solid-state battery may normally operate even though the unit cells are just bonded when laminating the unit cells. Since the short circuit of the solid-state cell mainly occurs if the highest pressure is applied, any short circuit at the unit cells may be easily detected such that the open circuit voltage may be accurately measured after the manufacturing process of each unit cell.

Moreover, since each unit cell is laminated by a simple contact method or an adhesive method, each unit cell may be easily separated from each other. When a short circuit unit cell is detected, only the short circuit unit cell may be selectively removed, and accordingly the solid-state battery may be easily recovered.

In the solid-state battery according to the present invention, an electron conductivity-reinforced layer may be interposed between the current collector of one unit cell and the electrode layer of another unit cell. The unit cells may be just adhered, not integrated through pressurization. Since the volume of the electrode layer contracts or expands as the battery is charged or discharged, the contacts between the current collector of one unit cell and the electrode layer of the next unit cell may not be uniform. In the present invention, the above-mentioned electron conductivity-reinforced layer may prevent the degradation of battery performance which may occur due to the poor contact.

### Example

The experimental examples of the present invention will be described below. The following experimental examples are provided for only illustrative purposes, so they are not intended to limit the scope of the present invention.

### Experimental Example 1

Capacity and voltage of an exemplary unit cell according to an exemplary embodiment of the present invention were measured.

An anode layer was formed on one surface of the current collector, and a solid electrolyte layer was formed on the anode layer. A cathode layer was formed on one surface of another current collector.

This experimental example 1 was directed to just measuring the capacity and voltage of the unit cell, so the cathode layer was formed on the current collector, not on a film, or the like.

The solid-state electrolyte layer and the cathode layer contacted each other, and both the laminated bodies were pressurized of 3 tons, thereby preparing a unit cell.

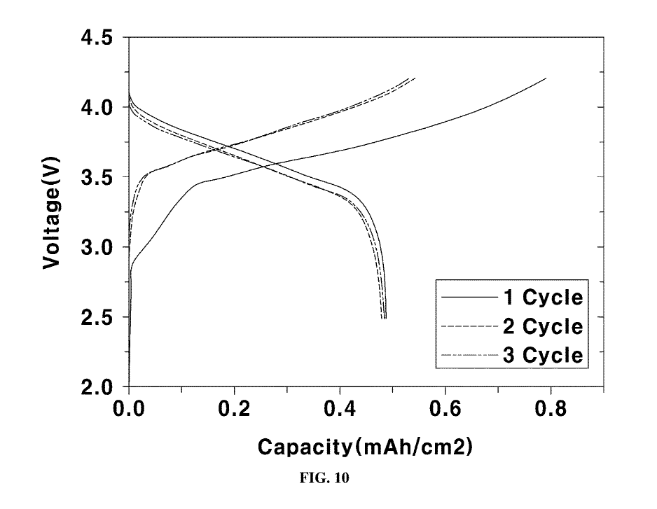

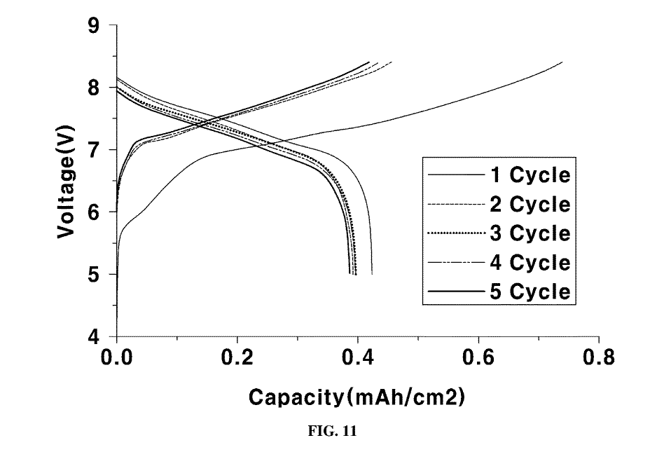

The capacity and driving voltage of the unit cell were measured. A result of the measurement is shown in FIG. 10 and the unit cell normally operated.

### Experimental Example 2

Capacity and voltage of an exemplary solid-state battery wherein two or more unit cells were laminated by a serial method according to the present invention were measured.

An anode layer was formed on one surface of the current collector, and a solid electrolyte layer was formed on the anode layer. A cathode layer was formed on one surface of the film.

The solid electrolyte layer and the cathode layer contacted each other, and both the laminated bodies were pressurized with a pressure of 3 tons, thereby preparing a unit cell.

In a first exemplary embodiment, a solid-state battery was manufactured in such a way to laminate two or more unit cells by the same method as in FIG. 4. Any pressure was not applied. A conductive adhesive was coated between the cathode layer and the current collector, and both the unit cells were bonded.

In a second exemplary embodiment, a solid-state battery was manufactured in such a way to laminate five unit cells by the same method as in FIG. 4. The lamination method was the same as the above method.

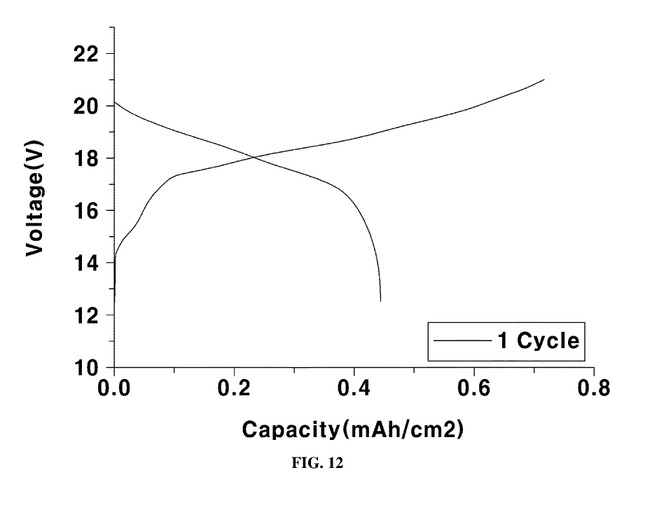

The capacity and driving voltage of the solid-state battery according to the first and second exemplary embodiments were measured. A result thereof is shown in FIG. 11 and FIG. 12.

Referring to the above result, the capacity similar to the experimental example 1 (a unit cell) was obtained. Moreover, the driving voltage was increased twice and five times, respectively, which meant that the energy density of the battery was increased. Accordingly, an exemplary solid-state battery wherein two or more unit cells were laminated was manufactured without any short circuit at each unit cell.

The invention has been described in detail with reference to various exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A solid-state battery comprising:
two or more of unit cells, each unit cell comprising a current collector, a solid electrolyte layer, and an electrode layer formed of an anode layer and a cathode layer,
wherein the two or more of the unit cells are laminated, and the neighboring unit cells are laminated such that a current collector of one unit cell contacts an electrode layer of a next unit cell.

2. The battery of claim 1, wherein the unit cell comprises a current collector, an anode layer, a solid electrolyte layer and a cathode layer, which are sequentially laminated in this order, and the neighboring unit cells are laminated such that a current collector of the one unit cell contacts a cathode layer of the next unit cell, thus manufacturing a solid-state battery of a serial cell structure.

3. The battery of claim 1, wherein the solid-state battery comprises a first unit cell comprising a first current collector, a first anode layer, a first solid electrolyte layer and a first cathode layer which are sequentially laminated in this order, and a second unit cell comprising a second current collector, a second cathode layer, a second solid electrolyte layer and a second anode layer which sequentially are laminated in this order, and the first unit cell and the second unit cell are laminated such that the first unit cell and the second unit cell are alternately laminated, and the electrode layers having same polarities are disposed on both surfaces of the current collector, thereby manufacturing a solid-state battery in a parallel structure.

4. The battery of claim 1, further comprising:
an electron conductivity-reinforced layer interposed between the neighboring unit cells.

5. A manufacturing method of a solid-state battery comprising:
preparing a unit cell by forming, on a current collector, a solid electrolyte layer, and an electrode layer comprising a cathode layer and an anode layer;
pressurizing the unit cell; and
bonding two or more of the unit cells such that a current collector of one unit cell contacts an electrode layer of a next unit cell.

6. The method of claim 5, wherein the unit cell comprises an anode layer, a solid electrolyte layer and a cathode layer, which are sequentially formed on the current collector in this order, and bonding the unit cells to form a serial cell structure such that the current collector of the one unit cell contacts a cathode layer of the next unit cell.

7. The method of claim 5, wherein the unit cell is prepared by steps comprising: preparing a first unit cell comprising a first anode layer, a first solid electrolyte layer and a first cathode layer on a first current collector, which are sequentially laminated; preparing a second unit cell comprising a second cathode layer, a second solid electrolyte layer and a second anode layer on a second current collector sequentially laminated, and the first unit cell and the second unit cell are alternately bonded, and the electrode layers having same polarities are disposed on both surfaces of the current collector, thereby form a parallel cell structure.

10. The method of claim 5, wherein an electron conductivity-reinforced layer is interposed between the unit cells when bonding the unit cells.

11. A vehicle comprising a solid-state battery of claim 1.
